(19) United States
(12) Patent Application Publication
(10) Pub. No.: US 2003/0018822 A1
(43) Pub. Date: Jan. 23, 2003

(54) Method and apparatus for administering multiple provisionable objects

(76) Inventors: Anne Robb, Casselberry, FL (US); Larry Weiser, Lake Mary, FL (US); John Gearhart, Lake Mary, FL (US)

Correspondence Address: Siemens Corporation, Intellectual Property Department, 186 Wood Avenue South, Iselin, NJ, 08830, US

(21) Appl. No.: 10/159,206

(22) Filed: May 30, 2002

Related U.S. Application Data
(60) Provisional application No. 60/294,201, filed on May 30, 2001.

(51) Int. Cl. G06F 15/16

(52) U.S. Cl. 709/250

(57) ABSTRACT

An apparatus and method are provided that allows a party to submit multiple requests for management activities to a telecommunications device in a single submission. The telecommunications device includes a network interface for communicating with the party to allow the party to submit the multiple requests in a single submission. The network interface downloads content for the party to select and downloads a program that aggregates the selections of the party into a suitable data structure. The data structure holds multiple requests for management activities in the telecommunications device and is transmitted to the telecommunications device in a single submission.

### RELATED APPLICATIONS

This application claims the benefit of priority under 35 U.S.C. 119(e) to copending U.S. Patent Provisional Applications, Serial No. 60/294,201 and filed on May 30, 2001, the contents of said application being incorporated by reference herein in its entirely.

This application is also related to the following U.S. Patent Applications: U.S. patent application Ser. No. ______ filed May 30, 2002 entitled AN INTEGRATED ACCESS PLATFORM; U.S. patent application Ser. No. ______ filed May 30, 2002 entitled METHOD FOR OPERATING AND APPARATUS FOR A BACK-PLANE SUPPORTING REDUNDANT CIRCUIT CARDS; U.S. patent application Ser. No. ______ filed May 30, 2002 entitled METHOD AND APPARATUS OF TESTING A POTS CIRCUIT AND DSL CIRCUIT THROUGH A SPLITTER; U.S. patent application Ser. No. ______ filed May 30, 2002 entitled METHOD AND APPARATUS FOR LOADING A MIRROR IMAGE SOFTWARE COPY ACROSS CIRCUIT CARDS; U.S. patent application Ser. No. ______ filed May 30, 2002 entitled METHOD AND APPARATUS FOR A COMMON MANAGEMENT SOFTWARE SYSTEM; U.S. patent application Ser. No. ______filed May 30, 2002 entitled METHOD AND APPARATUS FOR PROVIDING A COMMON TEXT MESSAGING SYSTEM WITHIN A SOFTWARE ARCHITECTURE; and U.S. patent application Ser. No. ______ filed May 30, 2002 entitled METHOD AND APPARATUS FOR PROVIDING A STATE MACHINE OPERATING ON A REAL-TIME OPERATING SYSTEM, the contents of each of said applications being incorporated by reference herein in their entirely.

### TECHNICAL FIELD OF THE INVENTION

The present invention generally relates to a telecommunication device and, more particularly, to management of the telecommunication device.

### BACKGROUND OF THE INVENTION

Conventional telecommunications devices typically provide some mechanism for remotely accessing management functions for the device. A typical mechanism is the script based command line interface (CLI). The CLI is a line based user interface that allows a user to perform a variety of network management functions, such as network monitoring, control, and troubleshooting. The CLI does not provide a graphical user interface.

Because the CLI is script based a user must carefully script a set of commands or requests before initiating a network management operation. Moreover the entering of the scripted commands is burdensome because a typographical mistake in entering a command results in an error message that requires the user to re-enter the command. As a result, the user of a CLI is burdened with having to learn the proper sequencing of commands in the telecommunications device, with having to learn the types of management activities associated with each command and with having to double check each command entry to ensure the entry of the correct command in the correct manner. Moreover, the user of a CLI is further burdened in that just one command can be entered at a time. Consequently, management of the telecommunication device via a CLI requires a substantial amount of manpower for training, developing command sequences, and submitting the command sequences for network management of the telecommunications device.

### SUMMARY OF THE INVENTION

The present invention addresses the above-described limitations of remotely accessing management activities in a telecommunications device. The present invention provides an approach to enable a graphical user network interface in the telecommunications device to receive and process multiple requests for management activities from a requestor in a single submission. The graphical user interface provides the user with a sequence of visual images that represent various elements of the telecommunications device in an intuitive format.

In one embodiment of the present invention, the method is practiced in a telecommunications device that has various elements of different types. The telecommunications device includes a network interface for use in communicating with a client device for performing management activities on the elements of the telecommunications device. The telecommunications device sends to the client device content for rendering, which when rendered provides a visual representation of the elements in a portion of the telecommunications device. As a result, a user of the client device may select multiple elements of a same type and select management activities to be performed on the selected elements.

The telecommunications device receives a communication from the client device at the network interface in a single session. The communication identifies both the elements selected by the user and the management activities selected by the user for performance on the selected elements. The communication includes a data structure holding data representative of the elements selected and the management activities selected for performance thereon. The data structure represents a compilation of the elements selected and the management activities selected for performance on the selected elements for the purpose of remote management of the telecommunications device in a single session.

The user navigates the content provided by the telecommunications device in a manner that corresponds to a hierarchy of elements in the telecommunications device. The user navigates through the content to select the multiple elements of a same type and to select the management activities for performance on the selected elements. The elements in the telecommunications device may include, for example, but are not limited to a circuit card assembly for providing a party access to a network, a port corresponding to a circuit card assembly that provides a physical connection to a network, and a data stream type for transporting data across a network.

The telecommunications device is also capable of downloading a program to run on the client device. The program aggregates the selected multiple elements of the same type and the selected management activities to be performed on the selected elements into a communication identifying the elements selected by the user and the management activities selected for performance on the selected elements.

In accordance with another aspect of the present invention, a telecommunications device is provided having an embedded network interface for communicating with at least one client device over a network. The embedded network interface sends content including a program for operation on the one client device. The content includes visual information for rendering on the client device a number of visual representations that depict various elements of the client device so that a user may select elements of a like type and request performance of management activities on the selected elements. The program aggregates the selected elements and the requested performance of management activities thereon into a communication that identifies the selected elements and the requested management activities to the embedded network interface. The telecommunications device further includes a processor for processing the communication to extract the selected elements and the requested management activities. A management facility is also provided in the telecommunications device for managing the device by performing the requested management activities for the selected elements. The device is an integrated access platform that handles both voice and data communications.

In yet another aspect of the present invention, a method is performed by a switch with an embedded web server in a telecommunications network. The switch sends multiple web pages from the embedded web server to a browser of a client device to allow a user of the client device to submit multiple requests for performance of multiple management operations in the switch in a single submission. At least one of the multiple web pages contains information allowing the browser to render a visualization of a portion of the switch. The switch also downloads a program to the browser for combining the multiple requests for the performance of the multiple management operations into a single data structure for submission to the server. The server processes the single data structure to identify the multiple requests for the performance of the multiple management operations submitted by the user in the single submission.

The embedded web server is capable of extracting the multiple requests for the performance of the multiple management operations from the data structure and sequencing the extracted multiple requests for the performance of the multiple management operations in a logical order for processing by a processor of the switch. The switch and the client device communicate using the Hypertext Transfer Protocol (HTTP).

The data structure can be a form encoded in a markup language, such as the Hypertext Markup Language (HTML). Moreover, the browser can render an in motion visualization of a portion of the switch. The elements rendered by the browser include a representation of a first type of circuit card assembly in the switch and a representation of a second type of circuit card assembly in the switch. The elements rendered by the browser further include a representation of one or more ports on one or more circuit card assemblies and one or more data stream types available for each of the ports on each of the circuit card assemblies.

In accordance with yet another aspect of the present invention, a method for allowing a client having a browser to manage operation of a telecommunications device having elements of different types and an embedded web server is provided. The method includes the steps of providing the telecommunications device, connecting the telecommunications device to the client using a communication medium capable of supporting propagation of communications between the telecommunications device. The telecommunications device sends to the client device a plurality of web pages from the embedded web server for rendering on the browser to show a visual representation of a portion of the telecommunications device that depicts the elements of different types. The user of the browser may select multiple elements of a same type and select management activities to be performed on the selected elements. The telecommunications device also sends a program that runs on the browser for collecting the selected multiple elements of the same type and collecting the selected management activities to be performed on the selected elements into a single communication. The method further provides the step of processing at the embedded server the single communication to perform the requested management operations of the selected elements in the telecommunications device.

The processing of the single communication containing the collected elements and the collected requests for management services on the collected elements includes unpacking the communication and formatting the selected elements into a format understandable by a processor of the telecommunications device. The processing of the single communication further includes the sequencing of the unpacked and reformatted selected elements and the corresponding management activities in a logical sequence for processing by the processor.

### BRIEF DESCRIPTION OF THE DRAWINGS

An illustrative embodiment of the present invention will be described below relative to the following drawings, in which like reference characters refer to the same parts throughout the different views.

FIG. 1 illustrates a representation of a telecommunications device in a network environment suitable for use and practicing an illustrative embodiment of the present invention.

FIG. 2 depicts a block diagram of the telecommunications device depicted in FIG. 1 suitable for practicing an illustrative embodiment of the present invention.

FIG. 3 depicts an exemplary screen shot of a rendered visualization of the elements of the telecommunications device suitable for practicing an illustrative embodiment of the present invention.

FIG. 4 depicts an exemplary screen shot of a navigation element suitable for practicing an illustrative embodiment of the present invention.

FIG. 5 depicts an exemplary screen shot of various elements that visualizes various elements of a telecommunications device suitable for practicing an illustrative embodiment of the present invention.

FIG. 6 depicts an exemplary screen shot of selected like elements of a telecommunications device suitable for practicing an illustrative embodiment of the present invention.

FIG. 7 depicts an exemplary screen shot of a selected element from the selected like elements of a telecommunications device suitable for practicing an illustrative embodiment of the present invention.

FIG. 8 depicts an exemplary screen shot of a port selection visualization associated with a telecommunications device suitable for practicing an illustrative embodiment of the present invention.

FIG. 9 depicts an exemplary screen shot of a data stream selection visualization in a telecommunications device suitable for practicing an illustrative embodiment of the present invention.

FIG. 10 depicts an exemplary screen shot of a visualization of a selected data stream type in a telecommunications device suitable for practicing an illustrative embodiment of the present invention.

FIG. 11 depicts an exemplary screen shot of a of a visualization of a second selected data stream type in a telecommunications device suitable for practicing an illustrative embodiment of the present invention.

FIG. 12 depicts an exemplary screen shot of a further visualization of the second selected data stream type in a telecommunications device suitable for practicing an illustrative embodiment of the present invention.

FIG. 13 is a block diagram that illustrates processing of a data structure suitable for use in practicing an illustrative embodiment of the present invention.

FIG. 14 is a block diagram that illustrates formation of a data structure processed in FIG. 13 that is suitable for use in practicing an illustrative embodiment of the present invention.

FIG. 15 is a flow diagram illustrating steps taken to practice an illustrative embodiment of the present invention.

### DETAILED DESCRIPTION

The illustrative embodiment of the present invention provides a telecommunication device having an interface that allows a user of a client device to submit multiple requests for management activities in a single submission. In the illustrative embodiment, the interface is adapted to provide content to the client device for rendering. The rendered content provides the user with a visualization of elements of the telecommunications device that are selectable for requesting the performance of management activities on the selected elements. The interface also provides the client device with a program that runs on the client device to aggregate the selected elements and the requests for management activities on the selected elements into a data structure suitable for transport to the network interface in a single submission.

In the illustrative embodiment, the interface is attractive for use in telecommunication devices that are remotely managed via a client device. The interface allows a user of the client device to submit multiple requests for management activities on elements of the telecommunications device in a single submission.

The illustrative embodiment provides a graphical user interface partitioned into multiple windows for management of a telecommunications device. In one window, a navigation tree is graphically represented, in a second window elements of the telecommunication device is graphically represented, in a third window, a status relating to the health of the telecommunications device is represented, and in a fourth window, various icons are graphically represented to assist a user in obtaining additional information relating to the telecommunications device. The graphical user interface allows a user to select multiple elements of a like type in the telecommunications device that are visually represented in one of the windows and request management activities for the selected elements in a single submission. As such, a user is able to submit a single request containing multiple requests for management activities on multiple like elements in the telecommunications device. Moreover, the user interface of the present invention is not limited to a graphical user interface and may include a menu-driven interface, a voice recognition system or other like user interface that provides an intuitive format for the user to navigate.

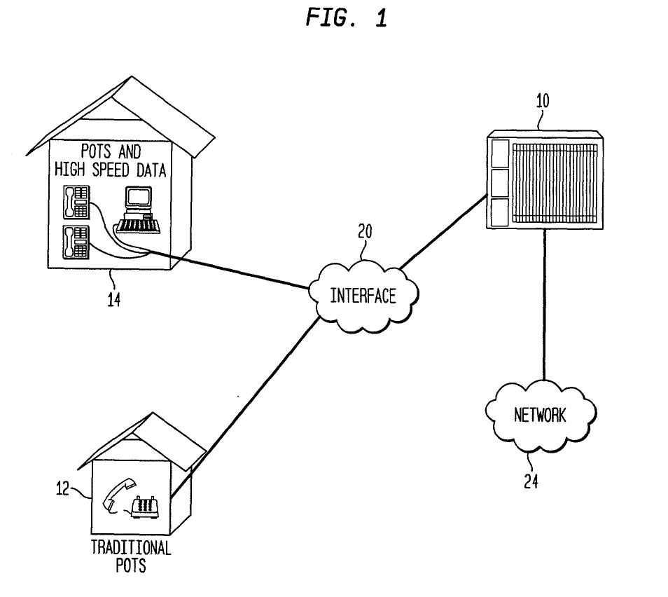

FIG. 1 illustrates an exemplary telecommunication device 10 in a network environment suitable for practicing an illustrative embodiment of the present invention. The exemplary telecommunication device 10 is capable of providing a first party 14 and a second party 12 with a connection to a network 24. For purposes of the discussion below, it is presumed that the exemplary telecommunication device 10 is an integrated access platform. Those skilled in the art will appreciated that the present invention may also be practiced with other types of telecommunication devices, including, but not limited to, routers, ATM switches, optical switches and the like. The exemplary telecommunication device 10 can provide multiple network connections of multiple types to a single party. For example, the exemplary telecommunication device 10 provides the first party 14 with a plain old telephone service (POTS) connection and a digital subscriber line (DSL) connection. In this manner, the exemplary telecommunication device 10 is capable of providing both voice and data communications to multiple parties.

Those skilled in the art will recognize that the first party 14 and the second party 12 are merely illustrative and that the exemplary telecommunication device 10 is capable of providing to one or more parties, over three hundred connections for POTS services and over four hundred connections for DSL services. Moreover, the exemplary telecommunication device 10 is capable of providing voice over DSL (VoDSL) and providing each party with access to a variety of network technologies, for example, asynchronous transfer mode (ATM), public switch telephone network (PSTN), frame relay, and internet protocol (IP).

The exemplary telecommunication device 10 is able to communicate with a variety of parties via the Hypertext Transfer Protocol (HTTP) to allow each party to manage one of their connections to the network 24. The exemplary telecommunication device 10 is able to communicate with a party via a network interface 20. The exemplary telecommunication device 10 allows each party to submit multiple requests for management activities on multiple elements of the telecommunications device in a single submission via the network interface 20. Those skilled in the art will recognize that the network interface 20 is an integral part of the exemplary telecommunication device 10 and that the illustration of the network interface 20 outside of the exemplary telecommunications device 10 in FIG. 1 is meant to facilitate understanding of an illustrative embodiment of the present invention.

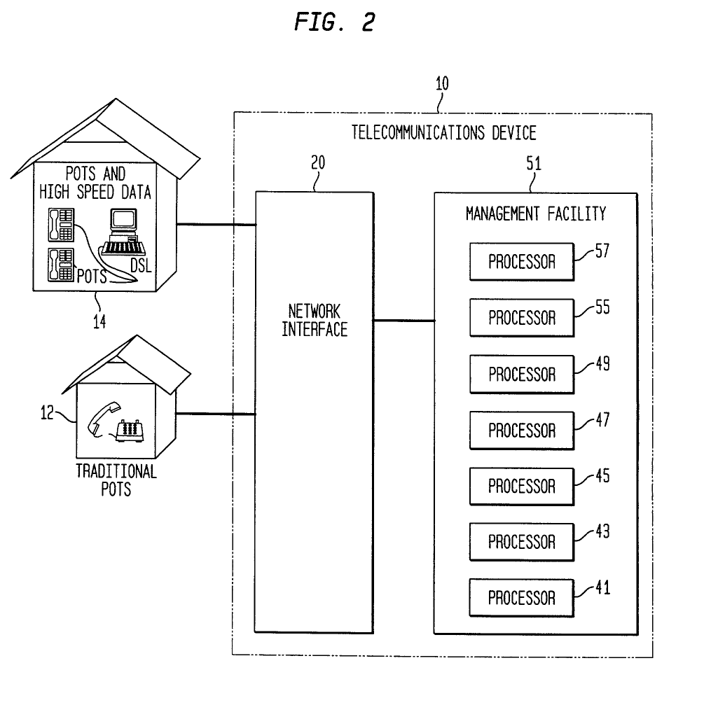

FIG. 2 illustrates the exemplary telecommunication device 10 in more detail. The exemplary telecommunication device 10 includes the network interface 20 that communicates with a management facility 51 and suitable client devices associated with the parties 12 and 14. The network interface 20 is responsible for communicating with the various client devices associated with each party via the hypertext transfer protocol (HTTP) and for translating requests for management activities from each party into a format understandable by the management facility 51. The network interface 20 is also responsible for translating a response from the management facility 51 from the format understandable by the management facility 51 to a format in which the corresponding request was received. The network interface 20 is able to communicate with a party device via the HTTP protocol to receive a single request for multiple management activities on multiple elements of the exemplary telecommunications device 10.

The management facility 51 includes one or more processors for processing the requests for management activities. The requests for management activities relate to different tasks within the exemplary telecommunications device 10, for example, administrative tasks, configuration tasks, debug tasks and test tasks. To handle the various types of tasks, the management facility 51 includes a processor 57 for processing requests relating to a status task of the exemplary telecommunications device 10. A processor 55 is also included in the management facility 51 for gathering active alarms associated with the exemplary telecommunication device 10. A processor 49 of the management facility 51 is responsible for providing a response to requests that relate to alarm and message processing in the exemplary telecommunication device 10. The management facility 51 further includes a processor 47 for providing a response to requests that relate to administration tasks, a processor 45 for providing a response to requests that relate to configuration tasks, a processor 43 for providing a response to requests that relate to a debug task, and a processor 41 for providing a response to requests that relate to a test task in the exemplary telecommunication device 10.

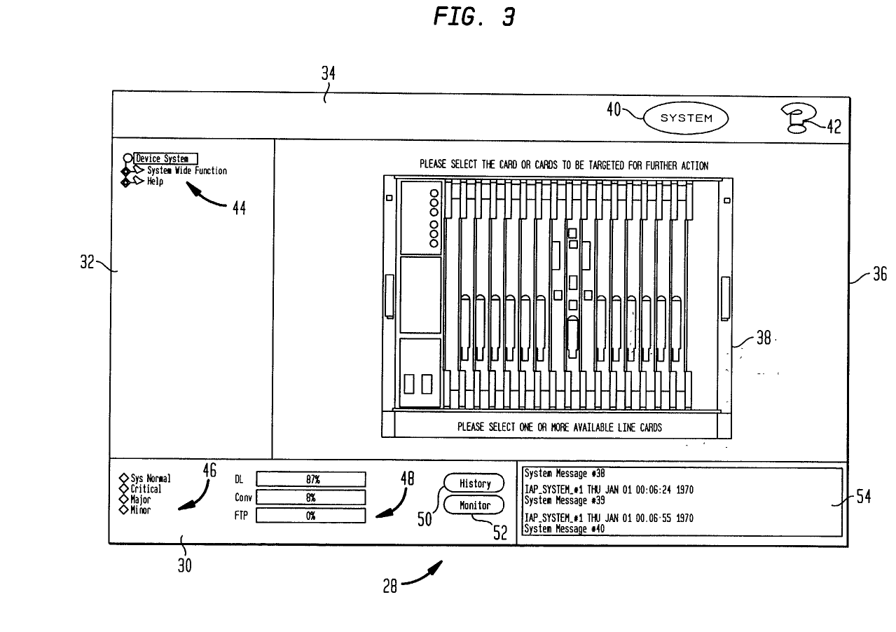

FIG. 3 is a depiction of an exemplary graphical user interface 28 suitable for use in the illustrative embodiment of the present invention. The graphical user interface 28 includes a banner region 34, a navigation region 32, a content region 36 and a status region 30. The banner region 34 is capable of displaying a graphical image of a company logo, such as a trademark or other like mark associated with the manufacture of the exemplary telecommunications device 10. The banner region 34 is also capable of displaying textual images that identify a physical site or location for the exemplary telecommunications device 10, and a textual image that identifies an element selected by the user. The banner region 34 can further include a number of icons that link a user to elements in other regions of the graphical user interface 28 when selected. For example, a system icon 40 that links the user to the navigation region 32 when the user selects the system icon 40, and a help icon 42 that links the user to a context sensitive graphical user interface element that is able to provide help content to be displayed in the content region 36 or to a function call that initiates a pop-up window or a pop-up box for a user to select help content.

The navigation region 32 provides a windows like navigation tree 44 to assist the user in navigating the graphical user interface 28. The graphical user interface 28 provides a visual representation of the elements contained in the exemplary telecommunications device 10 in a manner that corresponds to a hierarchy of elements in the exemplary telecommunications device 10. The navigation tree 44 includes subordinate levels that are expanded or collapsed by selection of a graphical user interface element containing a “+” symbol or a “−” symbol. These symbols can be selected with a pointing device, such as a mouse, light pen, or a users finger tip in a touch screen environment. The graphical user interface elements containing the “+” symbol indicates a subordinate level that is collapsed, while the “−” symbol indicates a subordinate level that is expanded in the navigation tree 44. The expanding and collapsing of a subordinate level or node in the navigation tree 44 does not change the view in any of the other regions, 30, 34, or 36. In this manner, a user is able to view all valid options for an element of the exemplary telecommunications device 10 before making a selection.

Each level or node in the navigation tree 44 acts as a link to a web page associated with a selected level or node. As such, the selection of a particular tree level or node from the windows like navigation tree 24 causes the current view of the content region 36 to change to the view associated with the web page linked to the selected tree level. In this manner, the user is able to navigate throughout the network interface 20 of the exemplary telecommunications device 10.

The navigation tree 44 typically includes subordinate level tree regions pertaining to system functions, help functions and a link to the main or home page of the network interface 20. The visualization of the navigation tree 44 displayed in the navigation region 32 depends on the element or elements of the exemplary telecommunications device 10 that are selected by the user and the access rights of the user. For example, if a management function is not allowed due to the access rights of the user or is invalid for the device selected, the navigation tree 44 does not display a tree level or node that corresponds to that particular management function.

The content region 36 displays multiple views of a web page provided by the network interface 20 of the exemplary telecommunications device 10. The views depicted in the content region 36 can contain one or more navigation icons that allow a user to move upwards or downwards through the various tree nodes of the navigation tree 44. Moreover, each navigation tree level or node in the navigation tree 44 corresponds to a view in the content region 36. A terminating tree node in the navigation tree 44 corresponds to a view in the content region 36 that contains a form, a report, or a message that indicates completion of a request for management activities or completion of a task.

Non-terminating tree nodes in the navigation tree 44 correspond to a view in the content region 36 having navigation links. Views for the non-terminating tree nodes in the content region 36 allow the user to navigate the network interface 20 of the exemplary telecommunications device 10. The views in the content region 36 that are associated with the non-terminating tree nodes in the navigation tree 44 serve to describe the available options under the currently selected subordinate tree level. The selection of a navigation link from a view in the content region 36 corresponding to a non-terminating tree node in the windows like navigation tree region 44 causes the selected subordinate tree level in the windows like navigation tree region 44 to expand if currently collapsed or to collapse if currently expanded.

The status region 30 stays substantially consistent as the views in the content region 36 change. As FIG. 3 depicts, the status region 30 can include a number of graphical user interface elements, such an alarm and status indicator 46, a progress region 48 containing one or more progression bars, a history button 50, a monitor button 52 and an active windows region 54 for actively displaying text messages from the exemplary telecommunications device 10. The alarm and status indicator 46 is considered an active graphical user interface element that provides a real time display of an alarm state and a status state of the exemplary telecommunications device 10. As such, the graphical user interface elements of the alarm and status indicator 46 are periodically updated by the network interface 20 to reflect a current state of the exemplary telecommunications device 10. The alarm and status indicator 46 include a number of visual indicators that indicate if the exemplary telecommunications device 10 is in a normal state, if the exemplary telecommunications device 10 is in a major alarm state, if the exemplary telecommunications device 10 is in a minor alarm state, or if the exemplary telecommunications device 10 is in a critical alarm state. Nevertheless, those skilled in the art will recognize that the alarm and status indicator 46 is adaptable to include fewer graphical indicators than illustrated or discussed, or adaptable to include more graphical indicators then the ones illustrated or discussed to provide a visual indicator to the user of other, states, events or functions occurring or not occurring in the exemplary telecommunications device 10.

The active graphical user interface elements in the alarm and status indicator 46 change color to provide the user with a visual indication of a state of the exemplary telecommunications device 10. In this manner, the alarm and status indicator 46 provides the user with a visual indication of the lack of or the presence of an alarm or a degraded system. In operation, the system normal indicator in the alarm and status indicator 46 is displayed green when there are no faults reported by the exemplary telecommunications device 10. The critical and major alarm indicators in the alarm and status indicator 46 are displayed in red when an alarm occurs in the exemplary telecommunications device 10 and the minor alarm indicator in the alarm and status indicator 46 is displayed in yellow when a minor alarm occurs in the exemplary telecommunications device 10. Each indicator in the alarm and status indicator 46 can also be displayed in a neutral color, such as gray to indicate an inactive state. Moreover, each indicator in the alarm and status indicator 46 can serve as a navigation link to a status view of the exemplary telecommunications device 10 that is rendered in the content region 36 upon selection of an indicator by the user.

Each progression bar provided in the progress region 48 of the status region 30 provides a visual indication regarding the progress of a task in the exemplary telecommunications device 10. Illustrated in FIG. 3 are three progression bars in the progress region 48, but those skilled in the art will recognize that progression bars can be added and removed as necessary by the client, and that the progress region 48 can display the progress of a task in an alternative manner, such as with a pie indicator, a counter or other like graphical user interface element suitable for use as a progression indicator. Moreover, the display of the progression bars in the progress region 48 can change as tasks are selected and deselected by the user. That is, when the user selects a new task, a progression bar can be rendered in the progress region 48 to provide a visual indication of the progress of the task selected. Tasks in the exemplary telecommunications device 10 that are often associated with a progression bar in the progress region 48 include a progression bar to indicate the progress of a data download to or from the exemplary telecommunications device 10. Another task that updates a progression bar to give a visual representation of the task progress includes a database copy function and a file transfer function in the exemplary telecommunications device 10.

The exemplary telecommunications device 10 is equipped with a log file that logs various alarms and messages from the various elements within the exemplary telecommunication device 10. The history button 50 is utilized by the user to access the content of the log file. Upon selection of the history button 50 a separate windows is displayed for rendering of the content of the log file. Those skilled in the art will recognize that the history button 50 can be represented by another graphical user interface element, such as a check box or other like element.

The monitor button 52 like the history button 50 institutes the creation of a new windows in the graphical user interface 28 when selected by the user. The selection of the monitor button 52 causes the new window to display textual information that indicates the physical site name of the exemplary telecommunications device 10. The selection of the monitor button 52 also causes the new window to display visual representations that represent various light emitting diodes (LED's) from an alarm display and test element of the exemplary telecommunications device 10 to allow the user to monitor the various LED's. The web page associated with the monitor button 52 also includes a visual representation of LED's from a system control panel, a task progression bar (not shown), an additional history button 50, a graphical user interface element linked to the home page of the network interface 20, and an expanded version of the active window 54.

The active window 54 serves as a small display to display the current alarms and messages from the exemplary telecommunications device 10. The active window 54 is an applet window downloaded from the network interface 20 that is programmed to have the alarms and messages scroll off the top of the active window 54. As illustrated, the active window 54 does not include scroll bars, but those skilled in the art will recognize that scroll bars can be included in the active window 54 and that the active window 54 can be programmed to have the alarms and messages scroll off the bottom of the active window 54 or to scroll across the active window 54.

The content region 36 displays all forms downloaded from the network interface 20 and displays all completion or error messages relating to a form submission to the network interface 20. The content region 36 is also the region where various web pages from the network interface 20 are rendered, for example, a home image 38 that provides a visual representation of the elements in the exemplary telecommunications device 10 that are available for selection by the user. The home image 38 and other web pages rendered in the content region 36 are discussed in more detail below.

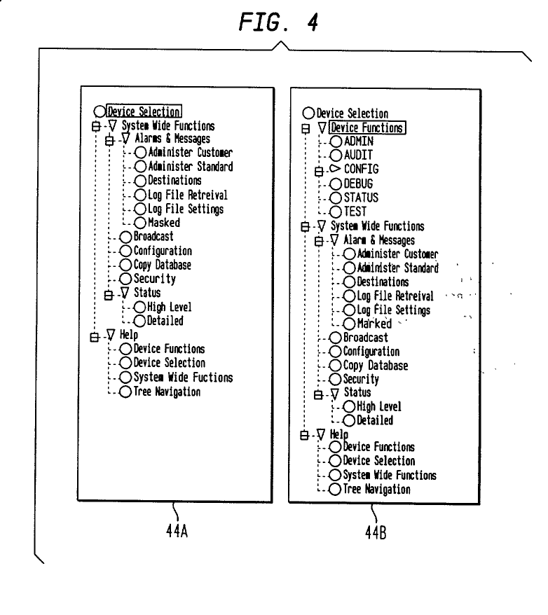

FIG. 4 depicts the navigation tree 44 in more detail. FIG. 4 illustrates a navigation tree 44A that is a representation of a home view of the navigation tree 44. The navigation tree 44A illustrates that the user has not selected an element of the exemplary telecommunications device 10.

As the navigation tree 44A illustrates, there are several subordinate tree levels including a system wide function subordinate level, an alarm and messages subordinate level, a status subordinate level, and a help subordinate level that are expandable and collapsible. A navigation tree 44B is also depicted in FIG. 4 to illustrate selection view of the navigation tree 44. The navigation tree 44B illustrates a selected subordinate tree function corresponding to a POTS element in the exemplary telecommunications device 10 selected by the user.

The selection of the subordinate tree function is indicated by the highlighting or the box element placed around the text identifying the subordinate tree level. The navigation tree 44B further illustrates that the device function selected by the user includes subordinate tree nodes that correspond to administration functions, audit functions, configuration functions, debug functions, status functions and test functions relating to the device selected that the user can select and request management activities relating the selected functions in the exemplary telecommunications device 10. Those skilled in the art will recognize that the selection of a POTS device is merely illustrative and that other devices such as a DSL device associated with the exemplary telecommunications device 10 can be selected by the user via the navigation tree 44.

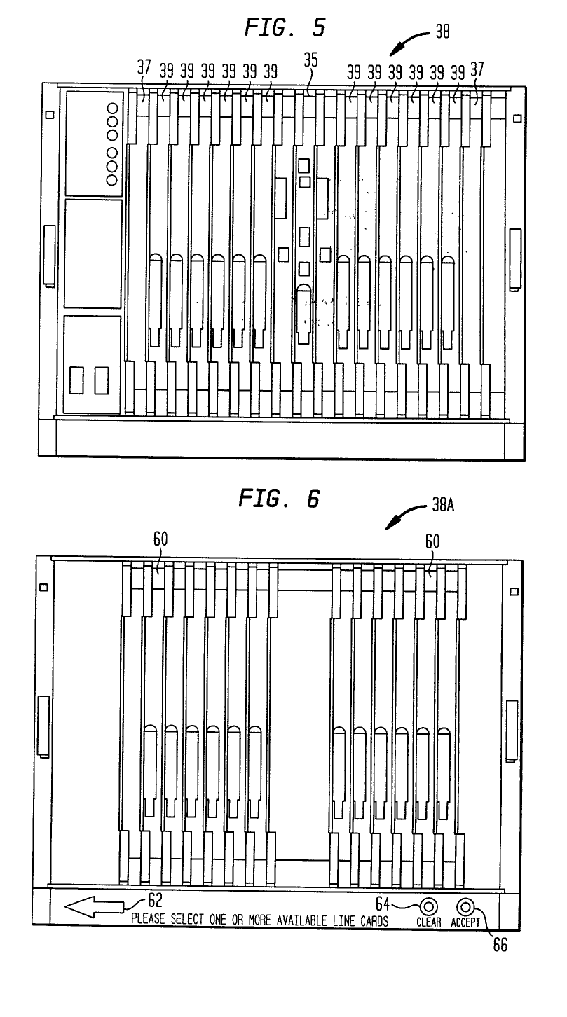

FIG. 5 depicts the home image 38 in more detail. The home image 38 is the first image the user sees after logging onto the network interface 20. The purpose of the home image 38 is to provide the user with a method for selecting an element or elements of a same type from which the user can retrieve information and perform requests for management activities on the selected elements in a single submission. Element selection from the home image 38 by the user is performed by having the user interact with a Macromedia Flash® movie presentation. Those skilled in the art will recognize that the network interface 20 can be configured to permit element selection from one or more web pages without the use of Macromedia Flash®.

The Macromedia Flash® presentation interacts with the user by initially displaying a vector graphic image of the exemplary telecommunications device 10 such as the home image 38. When ready, the user selects an element from the home image 38 by positioning an on-screen indicator or icon, such as a cursor associated with a pointing device over an element visually represented in the home image 38. The home image 38 depicts a number of visual representations of a number of elements contained in the exemplary telecommunications device 10. The elements visualized in the home image 38 include, for example, but are not limited to by type or number a POTS element 39, a DSL element 37, and a network interface element 35. The POTS element 39 provides a party with a POTS connection to the network 24. The DSL element 37 provides a DSL connection to the network 24. The network interface element 35 provides a party with a choice of data stream types through the network 24. Depending on the element the user selects, a response of the network interface 20 is to select the element or present a second image containing multiples of the original element.

FIG. 6 illustrates the display of a second image 38A that depicts the selection of each POTS element 39 depicted in the home image 38. The second image 38A illustrates the selection of each POTS element 39 as one or more grouped elements containing multiples of the original element selected, in this instance the POTS element 39. Those skilled in the art will recognize that the DSL elements 37 are also grouped into one or more grouped elements when one of the DSL elements 37 are selected from the home image 38. The multiple like elements 60 of the POTS element 39 are illustrated in the second image 38A using an alternate color or shading or other suitable visual effect to indicate to the user that the these elements are all like or same elements and that they have been selected by the user for further processing. Once the like elements have been selected as a group, the user can select or deselect one or more of the like elements by selecting an individual representation of each element using the pointing device. The user can return to the previous image by clicking on a back button 62 or can cancel a selection of one element or the selection of all elements by selecting a graphical user interface button 64 labeled clear. The user can also select a graphical user interface button 66 labeled accept to indicate to the network interface 20 that the user accepts the selection of the visually identified elements of the exemplary telecommunications device 10.

The like elements 60 provides a visual representation of one or more like elements housed within the exemplary telecommunications device 10. The visual representation of the multiple like elements 60 housed in the exemplary telecommunications device 10 represent like assemblies that provide like functions. For example, the exemplary telecommunications device 10 is an integrated access platform that provides both POTS and DSL services for one or more parties through the network 24 for the purpose of voice and data communications. As such, the exemplary telecommunications device 10 can contain multiple assemblies that provide connections to the network 24 for POTS and DSL services. Accordingly, the user via the home image 38 can select or deselect one or more of the visual representations of the elements that provide the POTS services or can either select or deselect one or more of the elements that provide the DSL services in the exemplary telecommunications device 10.

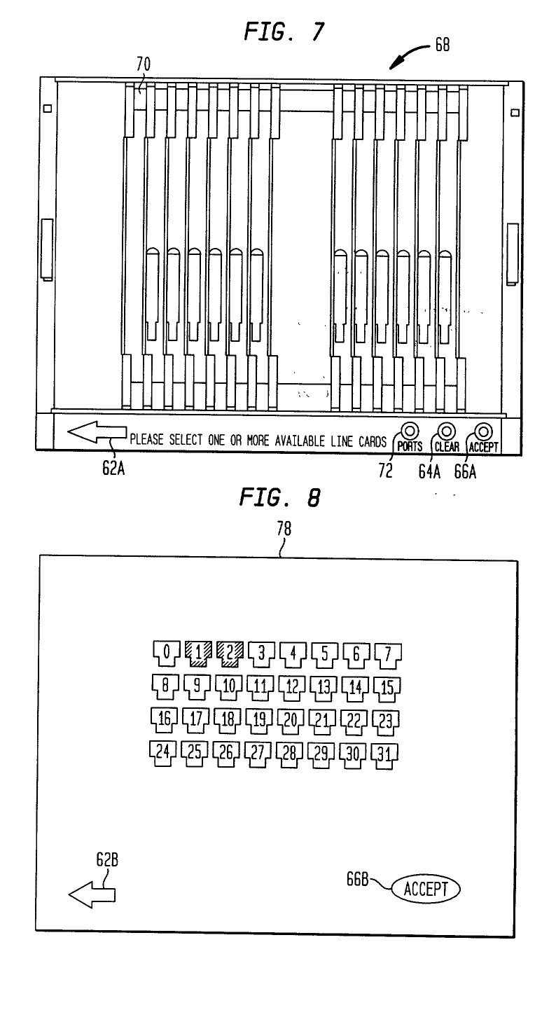

FIG. 7 depicts a rendering of an element image 68 that illustrates a selected one of a single element 70 from the like elements 60 illustrated in FIG. 6. The user selects the single element 70 using the pointing device. When the single element 70 is selected, the visualization of the single element 70 includes a text field that reads “selected” and includes other visual representation techniques that indicate to the user that the single element 70 is selected from the like elements 60. The other visualization techniques can include the use of shading, highlighting, outlining or other suitable visualization technique to provide the user with a visual indicator that differentiates between a selected element and a non-selected element.

In addition, the element image 68 includes a graphical user interface button 72 labeled ports. Selection of the ports button 72 by the user causes a secondary image to be rendered that provides a visual representation of the ports of the selected single element 70. The element image 68 further includes a back button 62A to cancel selection of the single element 70 and return to the previous image. Selection of a clear button 64A by the user cancels the selection of the single element 70 without navigating to another image. An accept button 66A is included in the element image 68 to allow the user to indicate to the network interface 20 that the user accepts the selection of the single element 70. Those skilled in the art will recognize that selection of the accept button 66A by the user indicates to the network interface 20 that the user accepts all selected elements if the user has selected more than the single element 70.

FIG. 8 illustrates a port selection image 78 that is rendered to provide the user a visual representation of one or more ports of the single element 70 when the ports button 72 is selected. Those skilled in the art will recognize that if the user selected multiples of the single element 70 and selects the ports button 72, a port selection image 78 one ore more visual representations are rendered to provide the user with a visual representation of ports associated with the multiple selected elements. The port selection image 78 displays each port available to the user for requesting a management function thereon in the single element 70. In this instance, the single element 70 has up to thirty-two ports available to connect a client device to the network 24. In operation, the user selects a desired image of an available port from the port selection image 78 for requesting management activities thereon. The port selection image 78 provides a visual indication of the selected ports to the user by changing a color or shading or highlighting of the selected visual representation of the port to indicate a visual difference between the selected and unselected ports associated with the single element 70. The user can return to the previously selected element image 68 by selecting the back button 62B. In addition, selection of the back button 62B deselects any selected port in the port selection image 78. If the user wishes to accept the selected ports, the user selects an accept button 66B to submit selection of the single element 70 and the selected ports of the single element 70 to the network interface 20 for processing.

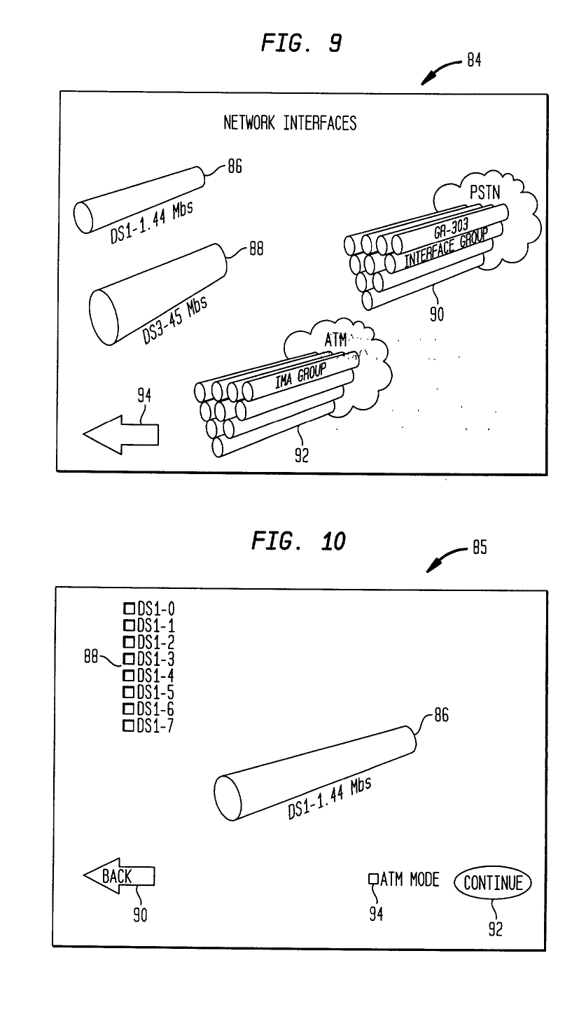

FIG. 9 depicts a network interface image 84 that provides a visual representation of the type of network interfaces or data streams available to the user. To reach the network interface image 84, the user selects from the home image 38, the visual representation of the network interface element 35 housed in the exemplary telecommunications device 10 responsible for the various network interfaces of the exemplary telecommunications device 10. Upon selection of the network interface element 35, the network interface image 84 is rendered to provide the visual representation of the various network interface elements available to the user. The network interface image 84 includes an icon 86 that provides a visual representation of a DS1 interface, an icon 88 that provides a visual representation of a DS3 interface, an icon 90 that provides a visual representation of a GR-303 interface, and an icon 92 that provides a visual representation of a asynchronous transfer mode (ATM) interface. Selection of one of the icons 86, 88, 90 or 92 allows the graphical user interface 28 to render additional visual representations of the selected network interface, for example a DS1 network interface image 85 illustrated in FIG. 10 or an ATM network interface image 95 illustrated in FIG. 11.

FIG. 10 illustrates a network interfaces image 85 of a secondary image displayed when the icon 86 representing the DS1 network interface is selected by the user. The network interfaces image 85 includes a number of check boxes 88 that are used to select or deselect one or more DS1 lines through the network 24. Those skilled in the art will recognize that other graphical user interface elements can be utilized to select or deselect one or more of the DS1 lines. For example, other suitable graphical user interface elements include a button that changes color or style based on selection or de-selection, or any other suitable graphical user interface element that allows a user to select or de-select a function or feature. The network interfaces image 85 includes a back button 90, which if selected by the user returns the user to the previously depicted image, for example the network interface image 84.

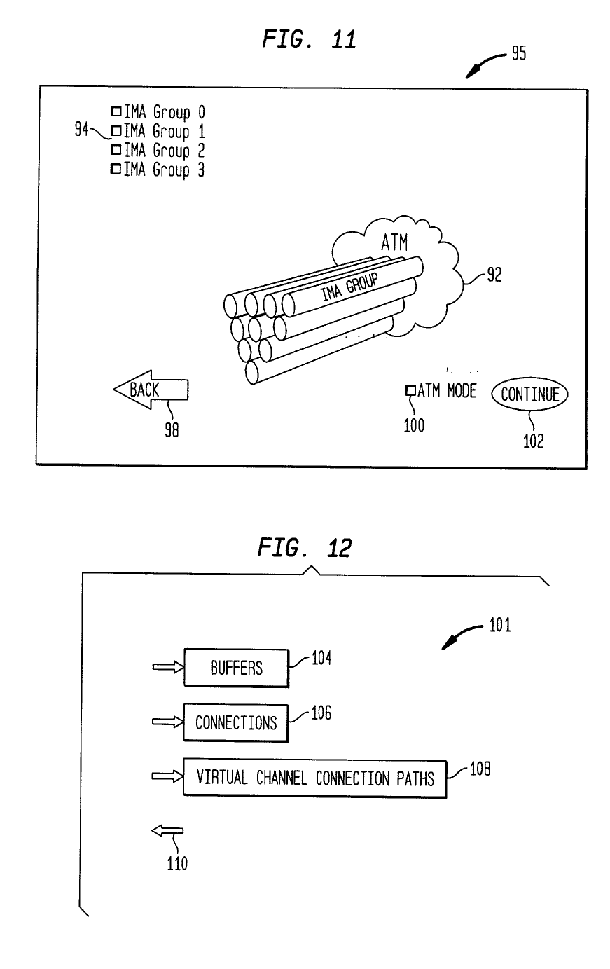

An ATM mode checkbox 94 and a continue button 92 are further included in the network interfaces image 85. The ATM mode checkbox 94 and the continue button 92 operate in conjunction with each other. That is, if the user selects the ATM mode via the ATM mode checkbox 94 selection of the continue button 92 advances the user to the ATM connection page sequence illustrated in FIGS. 11 and 12.

FIG. 11 depicts an ATM network interface image 95 that is rendered when the ATM icon 92 is selected from the network interfaces image 84 or when the user from the network interfaces image 85 selects the ATM mode checkbox 94 and the continue button 92. The ATM network interface image 95 includes one or more checkboxes 96 that are used to select or de-select inverse multiplexing ATM over an ATM connection through the network 24. The ATM network interface image 95 includes a back button 98, which if selected by the user returns the user to the network interfaces image 85 in FIG. 9 or to another previous image. An ATM mode checkbox 100 and a continue button 102 are included in the ATM network interface image 95. Selection of the ATM mode checkbox 100 and the continue button 102 advances the user to an ATM connections image 101 graphically depicted in FIG. 12.

The inverse multiplexing ATM checkboxes 96 allows the user to speed up data transmission through the network 24 by dividing a data stream into multiple concurrent streams that are transmitted at the same time across separate channels and are then reconstructed at the other end back into the original data stream. As such, by using multiple DS1 lines, the data stream can be load balanced across all of the lines at the same time. As such, inverse multiplexing across up to eight DS1 lines can be less expensive than the cost of a DS3 line.

FIG. 12 depicts the ATM connections image 101 that provides one or more graphical user elements to the user for navigating through the elements of the exemplary telecommunications device 10 that relate to managing an ATM network connection. These graphical user interface elements include a buffers button 104 that allows the user to navigate through the processing associated with a specific ATM connection through the network 24. A connection button 106 is included in the ATM connections image 101 that sends the user to another screen image when selected to allow the user to choose a virtual path or a virtual channel. A virtual channel connection path button 108 is also included that sends the user to an image that allows the user to select a virtual path identifier and a virtual path for a virtual channel connection. The ATM connections image 101 also includes a back button 110 that returns the user to the previously depicted image or screen when selected.

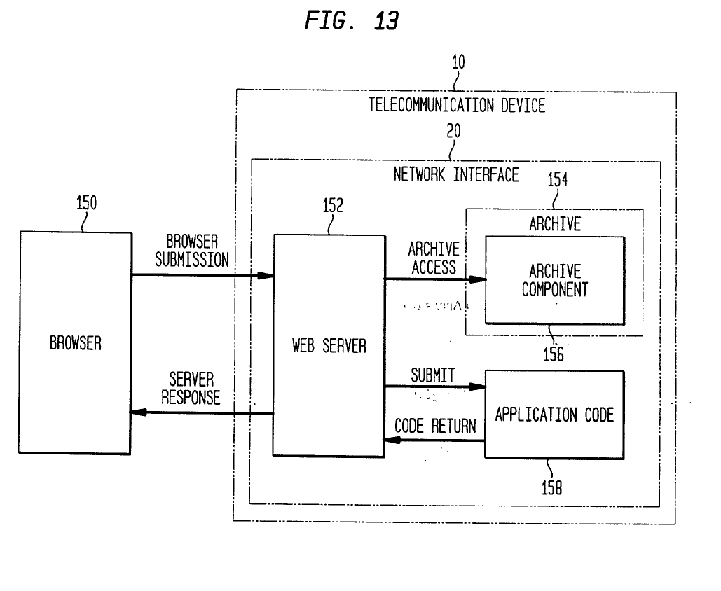

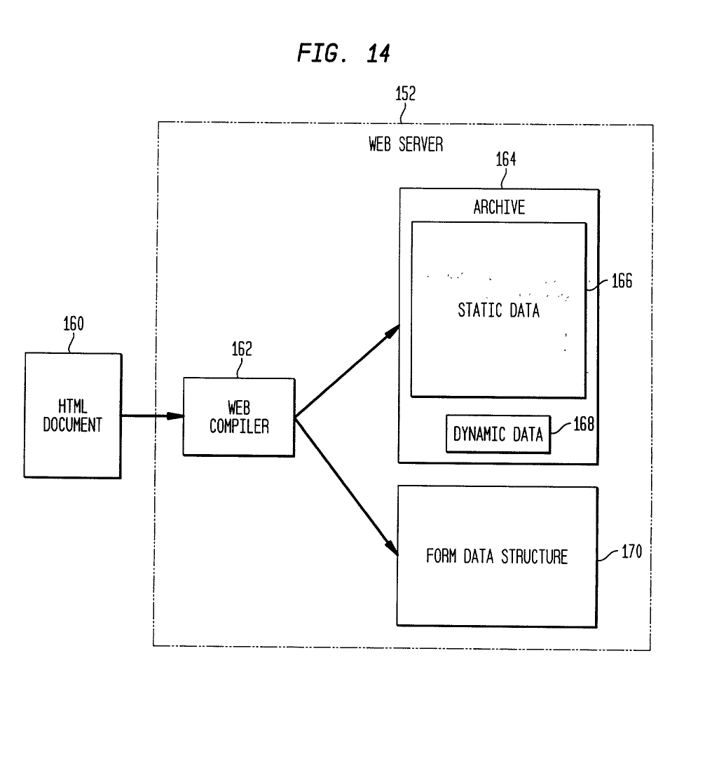

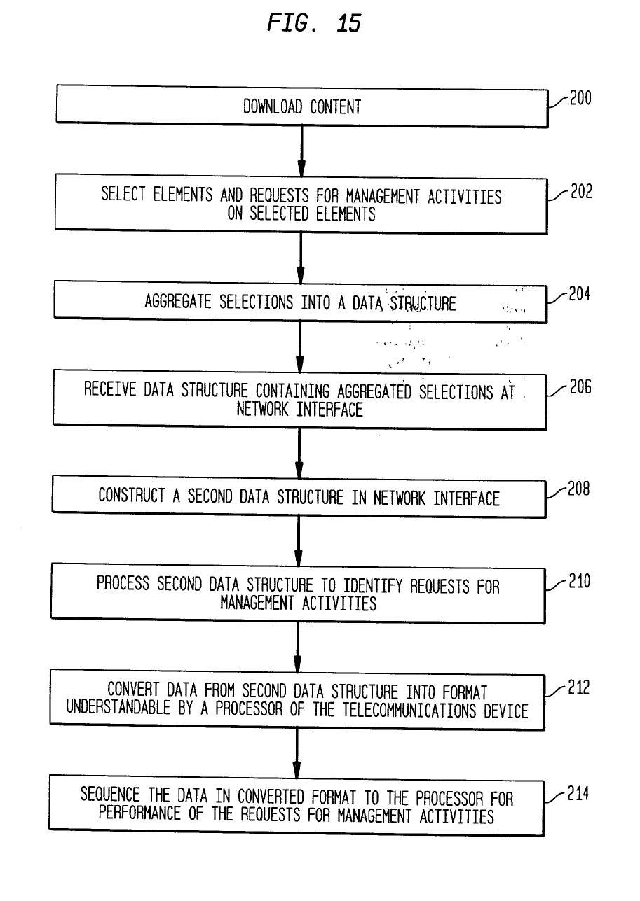

FIG. 13 is a block diagram that depicts the communication flow between the exemplary telecommunication device 10 and a selected client device of the parties 12 or 14. The parties 12 and 14 each utilize a client device to communicate with the exemplary telecommunications device 10. The block diagram of FIG. 13 illustrates the process that occurs when a browser of the client submits a communication containing multiple elements and multiple request for management activities for the multiple elements to the exemplary telecommunications device 10. FIG. 13 is discussed below in conjunction with FIGS. 14 and 15.

A web server 152 of the network interface 20 communicates with a browser 150 of the client device to download content for rendering a visual representation of multiple elements of the exemplary telecommunications device 10 and to collect multiple requests for management activities on the multiple elements in a single submission (Step 200 in FIG. 15). The web server 152 is considered an embedded web server of the network interface 20. The user navigates the supplied content via the browser 150 to select multiple like elements and request multiple management activities on the like elements (Step 202 in FIG. 15). The web server 152 receives from the browser 150 a communication that contains an aggregated selection of requests for management activities selected by the user via the graphical user interface 28 described above in connection with FIGS. 3 through 12. The communication includes a form data structure 170 that is encoded in a markup language, such as the hypertext markup language (HTML). The form data structure 170 contains one or more bitmaps that represent the elements selected and the requests for management activities selected for each element. For each element selected and for each function selected from the graphical user interface 28 there is a corresponding bitmap that retains the selected elements and the selected management functions selected by the user.

In more detail, the web server 152 utilizes a number of bitmaps to hold the various user selections. The web server 152 holds a bitmap for each like element type, for example, a bitmap associated with all POTS devices that visually represented in the graphical user interface 28. The bitmap associated with the visually represented POTS devices identifies each POTS device rendered by location in the exemplary telecommunications device 10. In this manner, when the user selects a like element from the home image 38, such as the multiple like elements 60 of the POTS element 39 illustrated in FIG. 6, the web server 152 sets a corresponding bit a bitmap that corresponds to the multiple like elements 60. The web server 152 sets the proper bit in the proper bitmap based on one or more variables that the browser uses to identify a POTS element 39 in the multiple like elements 60. Thus when the user selects one of the multiple like elements 60, for example, the single element 70 the web server 152 sets a corresponding bit in the bitmap associated with the visualization of the multiple like elements 60 to indicate selection of the single element 70 based on the variables sent by the browser 150. The bitmap associated with the multiple like elements 60 holds bits in logical locations that correspond to the visual locations of each like element rendered.

If the user selects the ports button 72 to navigate to the port selection image 78 the web server 152 in like manner associates all received variables with the bitmap that is associated with the port selection image 78. This bitmap like the bitmap discussed above associated with the multiple like elements 60 is utilized to hold the port selections of the user for the associated single element 70.

When the user selects the accept button 66, the browser 150 indicates to the web server 152 that the selection process is complete and that the web server 152 can begin aggregating the various selections (Step 204 in FIG. 15). The web server 152 through the selection process appends the various bitmaps to the links in various web pages for the tree nodes that are illustrated in the navigation tree 44, 44A and 44B. The bitmaps are appended to the links that correspond with the device type selected. The device information is appended to appropriate tree node link so the information is not lost as the user moves through the tree nodes. When a user selects a tree node the device information is passed back to the server in a form data structure 170 which the web server 152 uses to set the appropriate bits in the appropriate bitmaps. The web server 152 upon receipt of the communication containing the form data structure 170 accesses an archive 154 holding an archive object component 156 (Step 206 in FIG. 15). Those skilled in the art will recognize that the collection and aggregation of the variables into bitmaps containing the user selections can be performed by a common gateway interface (CGI) script or by any other server based technology.

The web server 152 accesses an internal form representation from the archive object component 156 and data entered by the user in the form data structure 170 to construct a second data structure for use in processing the requests for management activities on the selected elements (Step 208 in FIG. 15). When the web server 152 has accessed the proper object from the archive object component 156, the web server 152 invokes a function call that passes the second data structure and the context of the submission from the browser 150 to an application 158 for processing (Step 210 in FIG. 15). The context of the request is determined by the web server 152 from the content that was downloaded by the web server 152 to the browser 150. The application 158 evaluates the data in the second data structure for errors and converts the data from the second data structure into a format understandable by the management facility 51 of the exemplary telecommunications device 10 (Step 212 in FIG. 15). A suitable web server is available from Embedded Applications Group located in Maynard Mass.

The application 158 sends the data in the second data structure to the management facility 51 and allows the web server 152 to process another request. The web server 152 waits for a response from the management facility 51 while the management facility 51 processes the request. When the web server 152 receives the response from the management facility 51, the web server 152 directs the response to the application 158 for translation into a suitable format for the client. The web server 152 in response to receipt of the data in the translated format from the application 158 sends a response to the browser 150 to indicate an acknowledgement that the request for management activities were received without error. In more detail, the application 158 is responsible for sequencing the data in the format understandable by the management facility 51 in a logical sequence to the management facility 51 for further processing (Step 214 in FIG. 15).

The application 158 is able to sequence the received data to the management facility 51 in a logical order. That is, the application 158 passes data, or bitmaps, to the management facility 51 by element type. For example, the bitmaps that relate to a single POTS element or the bitmaps that relate to a single DSL element or the bitmaps that relate to one of the network interface elements. The application 158 when composing a request for management activities for presentation to the management facility 51 groups the requests by element type and formats each request into a communication of a suitable size (number of bytes) for the management facility 51. That is, each request from the application 158 to the management facility 51 has a maximum data unit size. If the request for management activities from the user exceeds the maximum data size for passing the request to the management facility 51, the application 158 repackages the request into a suitable number of requests in the format understandable by the management facility 51.

If the application 158 receives a request for management activities that exceeds the maximum data size for the management facility 51, the application 158 repackages the bitmaps contained in the request for management services into a number of requests having a bit size suitable for the management facility 51. In this manner, the management facility 51 in conjunction with the application 158 are able to loop through the various bitmaps to sequence the bitmaps by element type to the management facility 51 for further processing. When the application 158 receives a request for management services that exceeds the bit size limitation of the management facility 51, the application 158 is able to break down the request by type of request and by the type of device type and sequences the bitmaps by selected device to the management facility 51.

The application 158 when sending a bitmap or a collection of bitmaps to the management facility 51 that exceeds a data limit of the management facility 51 sets an initial value (begin) in a qualifier field of the communication that indicates that additional related communications are to follow. The management facility 51 in response to the initial value in the qualifier field passes a corresponding next value of the qualifier (next, last) in the response to the application 158. The application 158 copies the qualifier value sent with the response into the qualifier field for the next communication containing the next logical sequence of data or ends the communication if the qualifier value in the response indicates a final response. In this manner, the application 158 in conjunction with the management facility 51 is able to sequence multiple requests for management activities on multiple elements of the exemplary telecommunications device 10 in a logical sequence.

Optionally, the application 158 and the management facility 51 are able to loop or sequence requests for management activities between each other by passing a bitmap back and forth that contains a set bit for each device selected by the user. In this manner, when the management facility 51 completes the processing of requests for management activities for a particular device, the management facility 51 clears a set bit in the bitmap that corresponds to the just completed device. Thus when the application 158 receives the bitmap back from the management facility 51 searches the bitmap for the next set bit in the bitmap to determine the next selected device for processing by the management facility 51.

FIG. 14 is a block diagram of the web server 152. The web server 152 is used to create the form data structure 170 from an HTML document 160. The HTML document is passed to a web compiler 162 of the web server 152. The web compiler 162 of the web server 152 creates the form data structure 170 by adding an HTML extension attribute to an HTML <FORM> tag in an HTML document 160. The name used for the HTML extension attribute is unique. The web compiler 162 creates a form name for the form data structure 170, by using the name given to the HTML extension attribute.

The web compiler 162 compiles the HTML document 160 and writes static form data, that is form data that does not change, and dynamic form data, that is form data that does change to the archive 164. The archive 164 includes a static data structure 166 for holding the static form data and a dynamic data structure 170 for holding the dynamic form data. When the HTML document 160 is compiled by the web compiler 162 the web compiler 162 generates the form data structure 170 and any associated form functions that correspond to the HTML document 160. Each form data structure 170 has at least two associated functions defined by the web compiler 162 that take the form data structure 170 as an argument.

The web server 152 invokes one function before it serves the form data structure 170 to the browser 150 to initialize the form data structure 170 before it is served. The web server 152 invokes the second function when the browser 150 sends a submit transaction for the form data structure 170 when the user selects the accept button 66. The second function is used to gather and validate the form information sent.

The forms provided by the web interface 20 are designed to have multiple presentation states. For example, a data input view, a form response view, and a form failure review. In addition, some forms include multiple data input views, such as add, change, delete, and the like views. The transition between the form presentation states is controlled by using multiple submit or accept action buttons 66 selected by the user. The accept action buttons 66 use a dedicated tag with an attribute value set to a known type and a unique name for an attribute that identifies the name of the form being submitted. Dynamic HTML is utilized in support of the multiple presentation states of the forms.

While the present invention has been described with reference to the above illustrative embodiments, those skilled in the art will appreciate that various changes in form and detail may be made without departing from the intended scope of the present invention as defined in the appended claims. For example, extensive mark-up language (XML) or other suitable mark-up language can be used to encode the data structure and the communications between the web server and a browser of the client device.

What is claimed is:

1. In a telecommunications device having elements of different types and a network interface for use in communicating with a client device, a method for interacting with said client device for performance of management activities on said elements of said telecommunications device, said method, comprising the steps of:
sending from said telecommunications device content for rendering on said client device to show a visual representation of a portion of said telecommunications device that depicts said elements of different types, wherein a user of said client device may select multiple elements of a same type and select management activities to be performed on the selected elements; and
receiving at said network interface a communication identifying the elements that have been selected by the user and the management activities that have been selected by the user for performance in a single session.

2. The method of claim 1, wherein the communication identifying the elements selected by the user and the management activities selected by the user includes a data structure holding data representative of said elements selected and said management activities selected, said data structure representing a compilation of said elements selected and said management activities selected to support the performance of the management activities in the single session.

3. The method of claim 1, wherein the user navigates the content to select the multiple elements of the same type and to select the management activities to be performed in a manner that corresponds to a hierarchy of elements in said telecommunications device.

4. The method of claim 3, wherein one of said elements comprises a circuit card assembly for providing a party access to a network.

5. The method of claim 4, wherein one of said elements comprises a port of said circuit card assembly.

6. The method of claim 5, wherein one of said elements comprises a data stream type.

7. The method of claim 1, further comprising the step of:
downloading from the telecommunications device a program to run on said client device, said program aggregating the selected multiple elements of the same type and the selected management activities to be performed on the selected elements into the communication identifying the elements that have been selected by the user and the management activities that have been selected by the user.

8. The method of claim 1, wherein the content comprises content from at least one web page.

9. The method of claim 1, wherein said client device comprises a browser for rendering said content.

10. The method of claim 1, wherein the network interface is an interface with a connectionless network.

11. The method of claim 1, wherein the connectionless network is the Internet.

12. A telecommunications device comprising:
an embedded network interface for communicating with at least one client device over a network, said embedded network interface sending content, including a program for operation on the at least one client device, said content including visual information for rendering on said client device a plurality of visual representations that depict various elements of said telecommunications device so that a user of said client device may select elements of a like type and request performance of management activities on the selected elements, said program aggregating the selected elements and the requested performance of management activities thereon into a communication that identifies the selected elements and the requested management activities to said embedded network interface.

13. The telecommunications device of claim 12, wherein said telecommunications device comprises a switch capable of providing a party access to a digital subscriber line (DSL).

14. The telecommunications device of claim 12, further comprising a processor for processing said communication to extract the selected elements and the requested management activities.

15. The telecommunications device of claim 12, further comprising a management facility for managing the telecommunications device, the management facility performing the requested management activities for the selected elements.

16. The telecommunications device of claim 12, wherein said device comprises an integrated access platform for voice and data communications.

17. The telecommunications device of claim 12, wherein the network interface is a web interface for interfacing with a network selected from the group consisting of an intranet, an extranet and the Internet.

18. In a telecommunications network having a switch with an embedded web server and a client device with a browser, a method performed by said switch comprising the steps of:
sending multiple web pages from the embedded web server to the browser to allow a user of the client device to submit multiple requests for performance of multiple management operations in said switch in a single submission wherein, at least one of the multiple web pages contains information allowing the browser to render a visualization of a portion of the switch;
downloading a program to the browser for combining the multiple requests for the performance of the multiple management operations into a single data structure for submission to the server; and
at the server, processing the single data structure to identify the multiple requests for the performance of the multiple management operations submitted by the user in the single submission.

19. The method of claim 18 further comprising the steps of:
extracting the multiple requests for the performance of the multiple management operations from the data structure; and
sequencing the extracted multiple requests for the performance of the multiple management operations in a logical order for processing by a processor of said switch.

20. The method of claim 18, wherein the switch and the client device communicate using the Hypertext Transfer Protocol (HTTP).

21. The method of claim 18, wherein the single data structure comprises a form encoded in a markup language.

22. The method of claim 21, wherein the markup language comprises Hypertext Markup Language (HTML).

23. The method of claim 18, wherein the browser renders an in motion visualization of the portion of the switch.

24. The method of claim 23, wherein the web pages depict elements of different types in said switch and said in motion visualization animates one or more frames having one or more layers in an animation sequence.

25. The method of claim 24, wherein said elements comprise a representation of a first type of circuit card assembly in said switch and a representation of a second type of circuit card assembly in said switch.

26. The method of claim 25, wherein said elements further comprise a representation of one or more ports on said first type of circuit card assembly and a representation of one or more ports on said second type of circuit card assembly.

27. The method of claim 26, wherein said elements further comprise a representation of a data stream type available for each of said one or more ports on said first type of circuit card assembly and a data stream type available for each of said one or more ports on said second type of circuit card assembly.

28. A device readable medium holding executable instructions for a telecommunications device having elements of different types, a network interface for use in communicating with a client device, said device readable medium allowing said telecommunications device to interact with said client device for performance of management activities on said elements of said telecommunications device by performing the steps of:
sending from said telecommunications device content for rendering on said client device to show a visual representation of a portion of said telecommunications device that depicts said elements of different types, wherein a user of said client device may select multiple elements of a same type and select management activities to be performed on the selected elements; and
receiving at said network interface a communication identifying the elements that have been selected by the user and the management activities that have been selected by the user for performance in a single session.

29. The device readable medium of claim 28 further performing the steps of:
authenticating the user of said client device as having access rights to said telecommunications device for the performance of the management activities; and
translating the communication from a connectionless protocol to a format understandable by a processor of said device.

30. The device readable medium of claim 28, wherein the connectionless protocol comprises a Hypertext Transfer Protocol (HTTP).

31. The device readable medium of claim 28, wherein the telecommunications device comprises a switch providing a party an integrated access platform for voice and data communications.

32. A method for allowing a client having a browser to manage operation of a telecommunications device having elements of different types including an embedded web server, the method comprising the steps of:
providing the telecommunications device;
connecting the telecommunications device to the client using a communication medium capable of supporting propagation of communications between the telecommunications device and the client device;
sending a plurality of web pages from the embedded web server for rendering on the browser of the client device to show a visual representation of a portion of said telecommunications device that depicts said elements of different types, wherein a user of said browser may select multiple elements of a same type and select management activities to be performed on the selected elements;
sending a program that runs on said browser for collecting said selected multiple elements of the same type and collecting the selected management activities to be performed on the selected elements into a single communication; and
processing at the embedded server, the single communication for the performance of the management operations in the telecommunications device.

33. The method of claim 32, wherein the step of processing the collected single communication comprises the steps of:
unpacking the communication from the client the selected elements and the management activities to be performed on the selected elements;
formatting the selected elements and the management activities to be performed on the selected elements into a format understandable by a processor of the telecommunications device; and
sequencing the selected elements and the management activities to be performed on the selected elements in a logical sequence for processing by said processor.

34. The method of claim 32, wherein at least one of the plurality of web pages comprises an object for adding motion to a portion of the visual representation of a portion of said telecommunications device rendered by the browser of the client upon the user selecting one of the multiple elements.
